(19) United States
(12) Patent Application Publication
(10) Pub. No.: US 2003/0163909 A1
(43) Pub. Date: Sep. 4, 2003

(54) Vehicle dash panel separating tool

(76) Inventor: William R. Burkhardt, Fort Smith, AR (US)

Correspondence Address: Bill D McCarthy, Fellers Snider Blankenship Bailey and Tippens P C, Bank One Tower, 100 North Broadway Suite 1700, Oklahoma City, OK, 73102-8820, US

(21) Appl. No.: 09/971,455

(22) Filed: Oct. 5, 2001

(51) Int. Cl. B23P 19/04

(52) U.S. Cl. 29/239

(57) ABSTRACT

A vehicle dash panel removing tool is formed by a rigid single strand wire-like rod having an end portion defining an open loop handle and a relatively short length of the other end portion turned at right angle and provided with a sharpened tip for manual insertion of the tip under an edge of a vehicle panel to be removed.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates to vehicle repair tools and more particularly to a tool for separating vehicle dash panels.

2. Description of the Prior Art

I do not know of any tool available on the open market for separating the components of a vehicle dash. These components are usually separated from each other primaryly by using screw drivers, of selected size which are manually forced at the screw driving end, between adjacent components on a vehicle dash wherein a component overlying one or more components is secured thereto by a friction fit snap fastener such that when the overlying panel is lifted by a screw driver interposed between the two panels adjacent one of the fastening points the top panel will “pop” off of the other or underlying panel. Many vehicle dash components are so securely fastened and tight fitting that it is sometimes difficult to maneuver the driving end of a screw driver between two panels. This invention solves this problem.

### BRIEF SUMMARY OF THE INVENTION

A rigid single strand wire-like high tension metallic rod, relativity small in diameter and having a shank portion of a given length, is provided at one end with a laterally projecting relatively short end portion substantially normal to the longitudinal axis of the shank. This laterally projecting end portion is arcuately curved in a lateral direction and provided with a converging sharp point end. The opposite end of the shank is provided with a handle which may be an open or closed loop of the wire-like material lying in a plane common with the laterally projecting end portion of the shank.

### BRIEF DESCRIPTION OF THE DRAWING

FIG. 1 is a side elevational view of the tool;

FIG. 2 is a left end view of FIG. 1; and,

FIG. 3 is a fragmentary perspective view of the panel separating end portion of the tool.

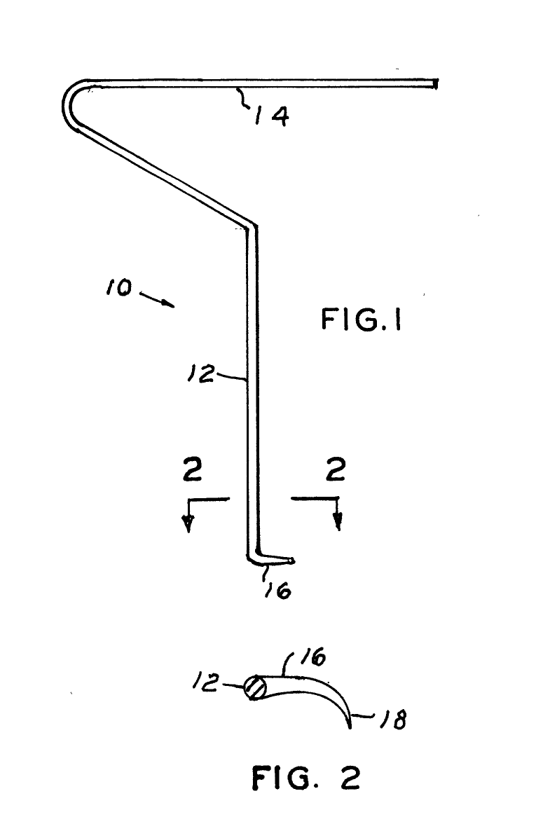

### DETAILED DESCRIPTION OF THE INVENTION

The reference numeral 10 indicates a wire-like tool having a shank portion 12 of selected length and an open loop handle 14 formed at one end of the shank. The other end of the shank has a relatively short portion 16 turned at right angle to the longitudinal axis of the shank 12. The laterally projecting end portion 16 is flattened and sharpened to form an arcuately curved tip, as at 18, (FIG. 2).

In operation the tool is manually grasped by the straight handle portion 15 to position the laterally projecting sharpened end portion 16 under the edge of a panel overlying a companion panel. The tool 10 is manually rotated about the longitudinal axis of its shank 12 by rotating the handle end portion 15 and the laterally projecting end portion 16 in a direction away from the underlying panel to separate the top panel from the lower one.

Obviously the invention is susceptible to changes or alterations without defeating its practicability. Therefore, I do not wish to be confined to the preferred embodiment(s) shown in the drawing(s) and described herein.

I claim:

1. A vehicle dash panel component separating tool comprising:
a rigid single strand wire-like member having a shank portion of given length and having one relatively short, when compared with the longitudinal length of the shank, sharpened end portion normal to the longitudinal axis of the shank; and,
a handle on the other end portion of the shank.

2. The panel separating tool according to claim 1 in which the handle comprises:
an open loop lying in a plane common with the right angular end portion.
